(19) United States
(12) Patent Application Publication
(10) Pub. No.: US 2013/0290850 A1
(43) Pub. Date: Oct. 31, 2013

(54) SYSTEM AND METHOD FOR MARKING SLIDE FILE USING LASER POINTER

(71) Applicant: CHUAN-CHI LIU, Tu-Cheng (TW)

(72) Inventor: CHUAN-CHI LIU, Tu-Cheng (TW)

(73) Assignee: HON HAI PRECISION INDUSTRY CO., LTD., Tu-Cheng (TW)

(21) Appl. No.: 13/592,361

(22) Filed: Aug. 23, 2012

(30) Foreign Application Priority Data
Apr. 25, 2012 (TW) 101114756

(51) Int. Cl. G06F 3/048

(52) U.S. Cl. 715/732

(57) ABSTRACT

A method for marking a slide file includes the following steps. Generating at least two reference spots on the slide file displayed by a display at preset reference coordinates of a displayed slide file. Obtaining an image of the slide file projected on a projection screen. Identifying the reference spots in the image and determining a standard coordinate of each reference spot in the image. Obtaining an association between the standard coordinates in the image and the preset reference coordinates in the displayed slide file. Obtaining a variety of images of the projected slide file. Identifying a bright spot in each image and determining its coordinate in each image. Calculating a coordinate of each bright spot in the displayed slide file according to the its determined coordinate in the image and the obtained association. Generating a continuous mark on the displayed slide file along the calculated coordinates.

### BACKGROUND

1. Technical Field

The present disclosure relates to projection systems, and particularly, to a system capable of marking a slide file using a laser pointer and a method adapted for the system.

2. Description of Related Art

Slide files pre-stored in a computer can be shown during a meeting to attendees by projecting the slide files to a projection screen via a projector connected to the computer. Furthermore, a presenter can press a button of a laser pointer to cause a small bright spot with colored light to appear on a desired area to highlight the area of the projected slide files.

However, when the laser pointer is moved from a first area to a second area of the projected slide file, the bright spot disappears from the first area, thus, the presenter cannot permanently mark the slide file using the laser pointer.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of a system of marking a slide file using a laser pointer, in accordance with an exemplary embodiment.

FIG. 2 is a schematic view showing a slide file and an image captured from the slide file, in accordance with an exemplary embodiment.

FIG. 3 is a flowchart of a method for marking a slide file using a laser pointer, in accordance with an exemplary embodiment.

### DETAILED DESCRIPTION

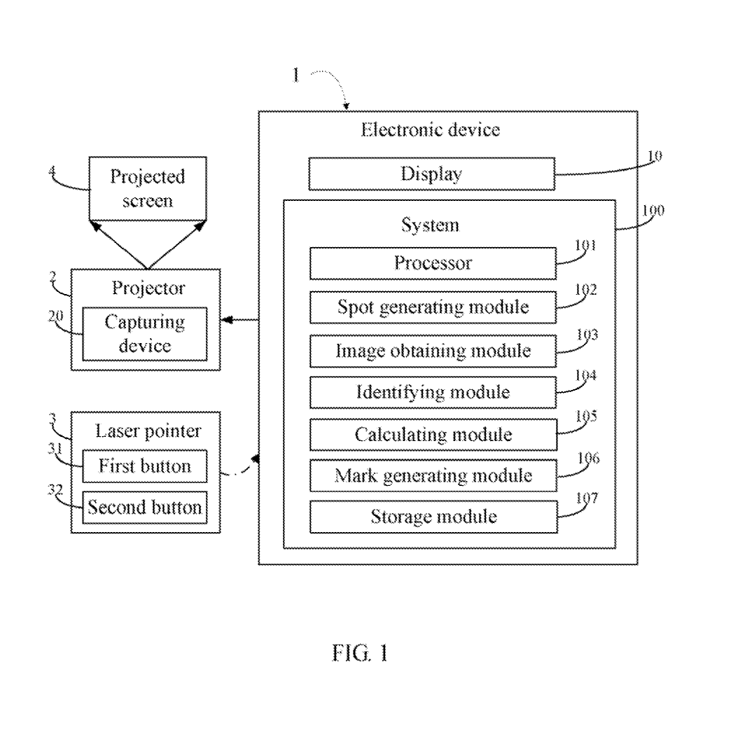

FIG. 1 is a block diagram of a system 100 according to an exemplary embodiment. The system 100 is included in an electronic device 1. The electronic device 1, such as a computer, includes a display 10 and is capable of displaying at least one slide file via the display 10. A projector 2 is connected to the electronic device 1 and configured to project the displayed slide file to a projection screen 4. A laser pointer 3 includes a first button 31 and a second button 32. When the first and the second buttons 31, 32 are pressed, the laser pointer 3 can communicate with the system 100 wirelessly to direct the system 100 to execute certain functions. A detail description of the directing method will be described in the following part.

The system 100 includes a processor 101 and a variety of modules executed by the processor 101 to provide the functions of the system 100. In the embodiment, the variety of modules includes a spot generating module 102, an image obtaining module 103, an identifying module 104, a calculating module 105, and a mark generating module 106.

After the slide file is displayed by the displayed 10, the spot generating module 102 generates at least two reference spots on the displayed slide file at preset reference coordinates of the displayed slide file, and the reference spots can be identified from the displayed slide file such as by different colors or different brightness for example. When the projector 2 is connected to the electronic device 1, the displayed slide file with the generated reference spots can be projected to the projection screen 4, thereby allowing the generated reference spots to appear as being placed over the projected slide file.

When the slide file with the reference spots is projected on the projection screen 4, the presenter can press the first button 31 of the laser pointer 3. The laser pointer 3 then generates a first request and transmits the first request wirelessly to the image obtaining module 103. The image obtaining module 103 obtains an image of the projected slide file in response to the first request, and then generates a first control signal. In the embodiment, the projector 2 further includes a capturing device 20 (e.g., a video camera) and the image obtaining module 103 is connected with the capturing device 20 and obtains the images of the projection screen 4 via the capturing device.

The identifying module 104 identifies the reference spots in the obtained image in response to the first control signal, and determines a standard coordinate of each identified reference spot in the obtained image. In the embodiment, the brightness of each generated reference spot is greater than the brightness of the displayed slide file, and the identifying module 104 identifies the reference spot in each obtained image according to the brightness difference. More specifically, the identifying module 104 obtains a grayscale value of each pixel of each obtained image, and compares the obtained grayscale value to a first predetermined value. If the obtained grayscale value is greater than the first predetermined value, the identified module 104 determines that the pixel is a pixel of the reference spot. All the determined pixels whose grayscale values are greater than the first predetermined value form the reference spots.

Since the projected slide file on the projection screen 4 is enlarged from the displayed slide file on the display 10, and the obtained image is captured from the projected slide file, thus, each reference spot in the obtained image corresponds to one reference spot in the displayed slide file on the display 10. That is, the standard coordinate of each reference spot in the obtained image corresponds to the preset reference coordinate of the reference spot of the displayed slide file. The calculating module 105 obtains the association between the standard coordinates in the obtained image and the preset reference coordinates in the displayed slide file. Thus, the coordinate in the displayed slide file corresponding to any coordinate in the obtained image can be further calculated by the calculating module 105 based on the obtained association.

After the association between the standard coordinates in the obtained image and the preset reference coordinates in the displayed slide file is obtained, the projected slide file can be marked using the laser pointer 3. More specifically, if the projected slide file needs to be marked, the presenter can keep pressing the second button 32 of the laser pointer 3 and then move the laser pointer. Then, a bright spot is generated on the projected slide file in response to the pressure and moved on the projection screen 4 with the movement of the laser pointer 3, and a second request is transmitted periodically to the system 100 until the second button 32 is released. The image obtaining module 103 obtains an image of the projected slide file in response to each second request, and then generates a second control signal.

The identifying module 104 identifies the bright spot in each obtained image in response to the second control signal, and determines the coordinate of each identified bright spot in the obtained image. In the embodiment, the brightness of the bright spot is greater than the brightness of the displayed slide file. The identifying module 104 obtains a grayscale value of each pixel of each obtained image, and compares the obtained grayscale value to a second predetermined value. If the obtained grayscale value is greater than the second predetermined value, the identified module 104 determines that the pixel is a pixel of the bright spot.

The calculating module 105 further calculates the coordinate of each bright spot in the displayed slide file according to the determined coordinate of each bright spot in the obtained image and the obtained association. A detail description of the calculating method will be described in the following part.

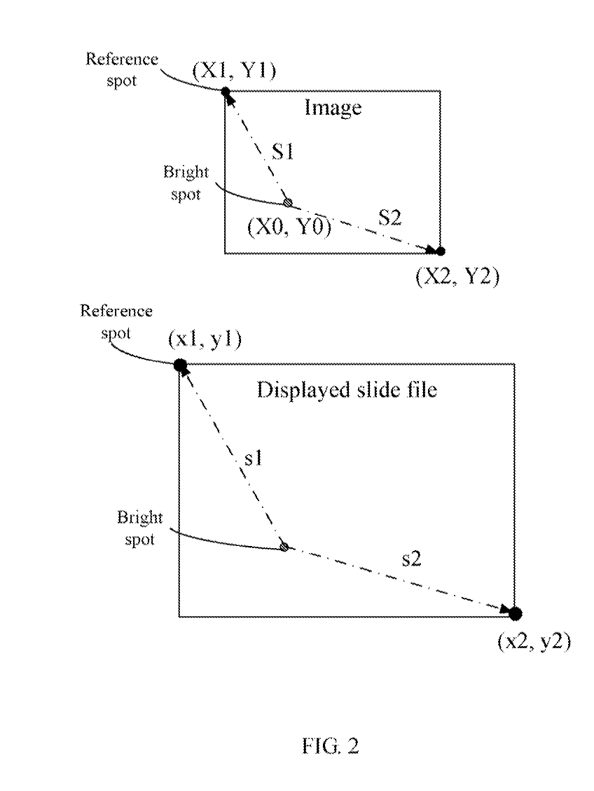

Referring to FIG. 2, in the embodiment, the spot generating module 102 generates two reference spots on the displayed slide file which are located at two opposite corners of the displayed slide file. However, it is notable that the number of the reference spots and the location of the reference spots relative to the displayed slide file are not limited thereto and can be varied to the need. The reference spots have preset reference coordinates in the displayed slide file, respectively labeled as (x1, y1) and (x2, y2). When an image of the slide file projected on the projection screen 4 is obtained, the two reference spots in the image are identified, and the standard coordinate of each identified reference spot is obtained, respectively labeled as (X1, Y1) and (X2, Y2). Because the standard coordinates (X1, Y1) and (X2, Y2) are correspondingly associated with the preset reference coordinates (x1, y1) and (x2, y2), a zoom factor (labeled as R) between the obtained image and the displayed slide file is calculated based on the distance between the preset reference coordinates (x1, y1) and (x2, y2) with respect to the distance between the standard coordinates (X1, Y1) and (X2, Y2). After the zoom factor R is calculated, the coordinate in the displayed slide file corresponding to any coordinate in the obtained image can be further calculated.

More specifically, when the coordinate of one bright spot in the obtained image is determined, which is labeled as (X0, Y0), the calculating module 105 calculates the distance (labeled as S1 and S2) between the determined coordinate (X0, Y0) and each of the standard coordinates (X1, Y1) and (X2, Y2), and then multiplies each of the calculated distances S1, S2 by the zoom factor R to obtain the distances (labeled as s1 and s2), which define the location of the bright spot in the displayed slide file with respect to the two reference spots. Then, the coordinate of the bright spot in the displayed slide file can be calculated based on the distances s1, s2 and the preset reference coordinates (x1, y1) and (x2, y2).

The mark generating module 106 generates a continuous mark on the displayed slide file along the calculated coordinates. Therefore, the projection screen 4 is allowed to display the slide file with the mark generated on the desired area of the slide file. In the embodiment, the mark generating module 107 further identifies the geometric characteristics of the generated mark, such as a direction, inclination or angle of each stroke of the generated mark, obtains a standard symbol according to the identified geometric characteristics, and then displays the standard symbol substituted for the generated mark on the displayed slide file such that the standard symbol is further allowed to be displayed on the slide file projected on the projection screen 4. In this case, the system 100 further includes a storage module 108 to store a variety of standard symbols.

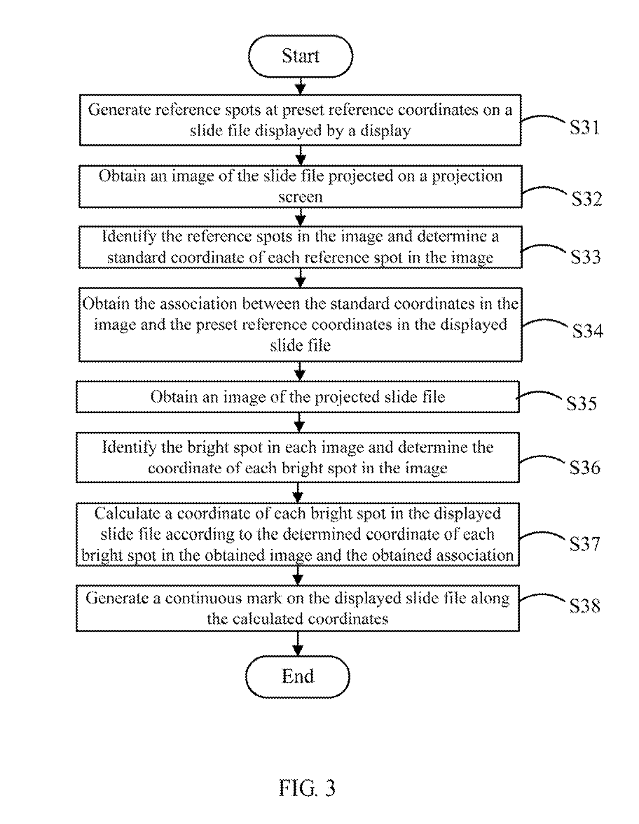

FIG. 3 is a flowchart of a method for marking a slide file using a laser pointer 3, in accordance with an exemplary embodiment.

In step S31, the spot generating module 102 generates at least two reference spots on the displayed slide file at preset reference coordinates of the displayed slide file.

In step S32, the image obtaining module 103 obtains an image of the projected slide file in response to a first request, and then generates a first control signal.

In step S33, the identifying module 104 identifies the reference spots in the obtained image in response to the first control signal, and then determines a standard coordinate of each identified reference spot in the obtained image.

In step S34, the calculating module 105 obtains the association between the standard coordinates in the obtained image and the preset reference coordinates in the displayed slide file.

In step S35, the image obtaining module 103 obtains an image of the projected slide file in response to each second request from the laser pointer 3, and then generates a second control signal.

In step S36, the identifying module 104 identifies the bright spot in each obtained image in response to the second control signal, and then determines the coordinate of each identified bright spot in the obtained image.

In step S37, the calculating module 105 calculates the coordinate of each bright spot in the displayed slide file according to the determined coordinate of each bright spot in the obtained image and the obtained association.

In step S38, the mark generating module 107 generates a continuous mark on the displayed slide file along the calculated coordinates. Therefore, the projection screen 4 is allowed to display the slide file with the mark generated on the desired area of the slide file.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for marking a slide file using a laser pointer, the system comprising:
a processor; and
a plurality of modules to be executed by the processor, the plurality of modules comprising:
a spot generating module to generate at least two reference spots on the slide file displayed by a display at preset reference coordinates of the displayed slide file;
an image obtaining module to obtain an image of the slide file with the generated reference spots projected on a projection screen in response to a first request from the laser pointer and generate a first control signal; and obtain an image of the projected slide file in response to each of a plurality of second requests from the laser pointer and generate a second control signal;
an identifying module to identify the reference spots in the obtained image in response to the first control signal and determine a standard coordinate of each identified reference spot in the obtained image; and identify a bright spot in each obtained image in response to the second control signal and determine a coordinate of each identified bright spot in each obtained image;
a calculating module to obtain an association between the standard coordinates in the obtained image and the preset reference coordinates in the displayed slide file; and calculate a coordinate of each bright spot in the displayed slide file according to the determined coordinate of each bright spot in the obtained image and the obtained association; and
a mark generating module to generate a continuous mark on the displayed slide file along the calculated coordinates.

2. The system of claim 1, wherein the projecting module is configured to generate two reference spots which are located at two opposite corners of the displayed slide file.

3. The system of claim 2, wherein the calculating module is further configured to calculate a zoom factor between the obtained image and the displayed slide file based on a distance between the preset reference coordinates with respect to a distance between the standard coordinates, calculate a distance between the determined coordinate of each bright spot and each of the standard coordinates, multiply each of the calculated distances by the zoom factor to obtain two distances defining a location of the bright spot in the displayed slide file with respect to the two reference spots, and then calculate the coordinate of the bright spot in the displayed slide file based on the obtained distances and the preset reference coordinates.

4. The system of claim 1, wherein the identifying module is further configured to obtain a grayscale value of each pixel of each obtained image, compare the obtained grayscale value to a first predetermined value, and determines a pixel with grayscale value greater than the first predetermined value to be a pixel of a reference spot.

5. The system of claim 1, wherein the identifying module is further configured to obtain a grayscale value of each pixel of each obtained image, compare the obtained grayscale value to a second predetermined value, and determines a pixel with grayscale value greater than the second predetermined value to be a pixel of a bright spot.

6. The system of claim 1, wherein the mark generating module is further configured to identify geometric characteristics of the generated mark, obtain a standard symbol according to the identified geometric characteristics, and display the standard symbol substituted for the generated mark on the displayed slide file.

7. The system of claim 6, further comprising a storage module, wherein the storage module is configured to store a plurality of standard symbols.

8. A method for marking a slide file using a laser pointer, the method comprising:
generating at least two reference spots on the slide file displayed by a display at preset reference coordinates of the displayed slide file;
obtaining an image of the slide file with the generated reference spots projected on a projection screen in response to a first request from the laser pointer and generating a first control signal;
identifying the reference spots in the obtained image in response to the first control signal and determining a standard coordinate of each identified reference spot in the obtained image;
obtaining an association between the standard coordinates in the obtained image and the preset reference coordinates in the displayed slide file;
obtaining an image of the projected slide file in response to each of a plurality of second requests from the laser pointer and generating a second control signal;
identifying a bright spot in each obtained image in response to the second control signal and determining a coordinate of each identified bright spot in each obtained image;
calculating a coordinate of each bright spot in the displayed slide file according to the determined coordinate of each bright spot in the obtained image and the obtained association; and
generating a continuous mark on the displayed slide file along the calculated coordinates.

9. The method of claim 8, wherein the generated reference spots are two reference spots located at two opposite corners of the displayed slide file.

10. The method of claim 9, wherein the step calculating a coordinate of each bright spot in the displayed slide file according to the determined coordinate of each bright spot in the obtained image and the obtained association comprising:
calculating a zoom factor between the obtained image and the displayed slide file based on a distance between the preset reference coordinates with respect to a distance between the standard coordinates;
calculating a distance between the determined coordinate of each bright spot and each of the standard coordinates;
multiplying each of the calculated distances by the zoom factor to obtain two distances defining a location of the bright spot in the displayed slide file with respect to the two reference spots; and
calculating the coordinate of the bright spot in the displayed slide file based on the obtained distances and the preset reference coordinates.

11. The method of claim 8, wherein the step identifying the reference spots in the obtained image in response to the first control signal comprises:
obtaining a grayscale value of each pixel of each obtained image;
comparing the obtained grayscale value to a first predetermined value; and
determining a pixel with grayscale value greater than the first predetermined value to be a pixel of a reference spot.

12. The method of claim 8, wherein the step identifying a bright spot in each obtained image in response to the second control signal comprises:
obtaining a grayscale value of each pixel of each obtained image;
comparing the obtained grayscale value to a second predetermined value; and
determining a pixel with grayscale value greater than the second predetermined value to be a pixel of a reference spot.

13. The method of claim 8, wherein the step generating a continuous mark on the displayed slide file along the calculated coordinates comprises:
identifying geometric characteristics of the generated mark;
obtaining a standard symbol according to the identified geometric characteristics; and
displaying the standard symbol substituted for the generated mark on the displayed slide file.
